(19) United States
(12) Patent Application Publication
(10) Pub. No.: US 2020/0120217 A1
(43) Pub. Date: Apr. 16, 2020

(54) IMAGE FORMING APPARATUS, ABNORMAL MEMBER DETECTION METHOD AND NON-TRANSITORY COMPUTER-READABLE RECORDING MEDIUM ENCODED WITH ABNORMAL MEMBER DETECTION PROGRAM

(71) Applicant: Konica Minolta, Inc., Tokyo (JP)

(72) Inventors: Tianhua XU, Toyokawa-shi (JP); Hiroaki TAKATSU, Nishio-shi (JP); Takeshi TAMADA, Toyohashi-shi (JP); Takahiro TSUJIMOTO, Toyokawa-shi (JP); Katsuyuki IKUTA, Hamamatsu-shi (JP)

(21) Appl. No.: 16/595,665

(22) Filed: Oct. 8, 2019

(30) Foreign Application Priority Data
Oct. 11, 2018 (JP) 2018-192799

(51) Int. Cl. H04N 1/00

(52) U.S. Cl. CPC H04N 1/00037; H04N 2201/0094; H04N 1/00074; H04N 1/00063

(57) ABSTRACT

An image processing apparatus includes a member controller that controls a drive prevented member that is prevented in advance from being driven in a standalone mode while an image processing operation is not being carried out, and a plurality of other normal members that are not the drive prevented member, and a hardware processor, wherein the hardware processor allows at least one of the plurality of normal members to be driven after an integrated signal indicating abnormality in at least one of the plurality of normal members is detected, and determines an abnormal member having abnormality from among the plurality of normal members based on presence or absence of the integrated signal with at least one of the plurality of normal members being driven.

### CROSS REFERENCE TO RELATED APPLICATION

The present invention claims priority under 35 U.S.C. § 119 to Japanese patent Application No. 2018-192799 filed on Oct. 11, 2018, the entire content of which is incorporated herein by reference.

### BACKGROUND

### Technological Field

The present invention relates to an image processing apparatus, an abnormal member detection method and a non-transitory computer-readable recording medium encoded with an abnormal member detection program. In particular, the present invention relates to an image processing apparatus that detects abnormality in any of a plurality of members, an abnormal member detection method that is performed in the image processing apparatus and a non-transitory computer-readable recording medium encoded with an abnormal member detection program that allows a computer controlling the image processing apparatus to perform the abnormal member detection method.

### Description of the Related art

In the case where an image processing apparatus represented by an MFP (Multi Function Peripheral) fails, a service person who is in charge of repair specifies the location that has failed. Because a plurality of members are installed in the image processing apparatus, it may be difficult to specify the member that has failed based on the state of the image processing apparatus, and it may require a long period of time to specify the cause. As the operation of specifying the cause of the failure, the service person specifies the unit, constituted by a plurality of members, that is the cause of the failure and specifies which one of the plurality of members included in the unit is the cause of the failure in the next step. In order to fix the failure of the image processing apparatus as quickly as possible, the service person may replace the unit specified as the cause of the failure without specifying the member that is the cause of the failure. While the failure can be fixed quickly in this case, the cost is high since the members that are not failing are replaced.

On the other hand, in the case where the service person forcibly operates the image processing apparatus in order to specify the cause of the failure, it is necessary to shorten the time during which the image processing apparatus is operated. Thus, it is necessary that the service person specifies the failure as quickly as possible.

If the states of all of the members included in the image processing apparatus are to be monitored respectively, the member that has failed while the image processing apparatus is being operated can be specified. For example, Japanese Patent Laid-Open No. 2005-033559 discloses a troubleshooting device that troubleshoots a failure in a device having a drive mechanism including a plurality of constituent members such as a drive member that operates in response to an electric current supply and a power transmission member that transmits a drive force of the drive member to another member and comprises an operation state signal detection portion that detects an operation state signal indicating an operation state while the drive mechanism is operating for a predetermined period of time, and a troubleshooting portion that carries out troubleshooting with respect to individual constituent elements that constitute the drive mechanism based on the degree of difference of an operation state signal detected by the operation state signal detection portion from a predetermined normal range in regards to the operation state signal. However, a device for detecting operation states of a plurality of drive mechanisms respectively and a circuit for monitoring the operation states of the plurality of drive mechanisms respectively are required, and the cost is increased.

### SUMMARY

According to one aspect of the present invention, an image processing apparatus includes a member controller that controls a drive prevented member that is prevented in advance from being driven in a standalone mode while an image processing operation is not being carried out, and a plurality of other normal members that are not the drive prevented member, and a hardware processor, wherein the hardware processor allows at least one of the plurality of normal members to be driven after an integrated signal indicating abnormality in at least one of the plurality of normal members is detected, and determines an abnormal member having abnormality from among the plurality of normal members based on presence or absence of the integrated signal with at least one of the plurality of normal members being driven.

According to another aspect of the present invention, an abnormal member detection method that is performed in an image processing apparatus includes a member control step of controlling a drive prevented member that is prevented in advance from being driven in a standalone mode while an image processing operation is not being carried out, and a plurality of other normal members that are not the drive prevented member, a step of allowing at least one of the plurality of normal members to be driven after an integrated signal indicating abnormality in at least one of the plurality of normal members is detected, and an abnormal member determining step of determining an abnormal member having abnormality from among the plurality of normal members based on presence or absence of the integrated signal with at least one of the plurality of normal members being driven.

According to yet another aspect of the present invention, a non-transitory computer-readable recording medium encoded with an abnormal member detection program that is executed in a computer controls an image processing apparatus, wherein the abnormal member detection program allows the computer to control a drive prevented member that is prevented in advance from being driven in a standalone mode while an image processing operation is not being carried out, and a plurality of other normal members that are not the drive prevented member, and allow at least one of the plurality of normal members to be driven after an integrated signal indicating abnormality in at least one of the plurality of normal members is detected, and determine an abnormal member having abnormality from among the plurality of normal members based on presence or absence of the integrated signal with at least one of the plurality of normal members being driven.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing the appearance of an MFP in a first embodiment of the present invention;

FIG. 2 is a block diagram showing the outline of the hardware configuration of the MFP in the first embodiment;

FIG. 3 is a schematic cross sectional view showing the inner configuration of the MFP in the first embodiment;

FIG. 4 is a diagram showing one example of a conversion circuit in the first embodiment;

FIG. 5 is a diagram showing one example of a drive circuit;

FIG. 6 is a block diagram showing one example of functions of a CPU included in the MFP in the first embodiment;

FIG. 7 is a diagram showing one example of operation states of members A to G and an integrated signal;

FIG. 8 is a diagram showing one example of a unit drive time table;

FIG. 9 is a diagram showing one example of an operation history table;

FIG. 10 is a flow chart showing one example of a flow of an abnormality detection process;

FIG. 11 is a flow chart showing one example of a flow of a priority order determining process;

FIG. 12 is a flow chart showing one example of a flow of a priority order determining process in a first modified example;

FIG. 13 is a diagram showing one example of a remaining time table;

FIG. 14 is a flow chart showing one example of a flow of a priority order determining process in a second modified example;

FIG. 15 is a diagram showing one example of a drive frequency table;

FIG. 16 is a flow chart showing one example of a flow of a priority order determining process in a third modified example;

FIG. 17 is a diagram showing one example of a table of contribution degree of safety;

FIG. 18 is a diagram showing one example of a conversion circuit in a fifth modified example;

FIG. 19 is a block diagram showing one example of functions of a CPU included in an MFP in a sixth modified example;

FIG. 20 is a diagram showing one example of an operation state table;

FIG. 21 is a flow chart showing one example of a flow of an abnormality detection process in the sixth modified example;

FIG. 22 is a block diagram showing one example of functions of a CPU included in an MFP in a second embodiment;

FIG. 23 is a second diagram showing one example of operation states of the members A to G and an integrated signal;

FIG. 24 is a third diagram showing one example of operation states of the members A to G and integrated signals;

FIG. 25 is a fourth diagram showing one example of operation states of the members A to G and integrated signals;

FIG. 26 is a fifth diagram showing one example of operation states of the members A to G and integrated signals; and

FIG. 27 is a flow chart showing one example of a flow of an abnormality detection process in the second embodiment.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

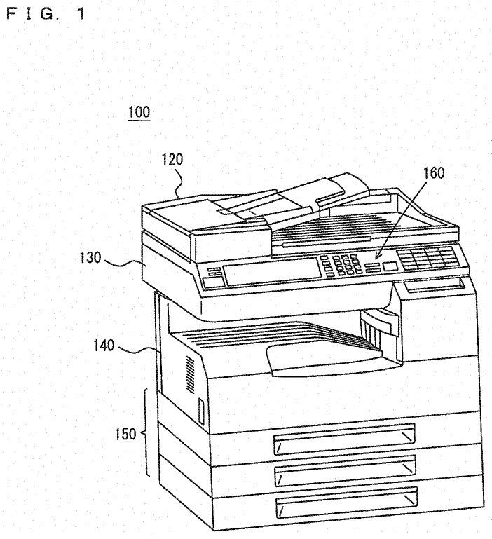

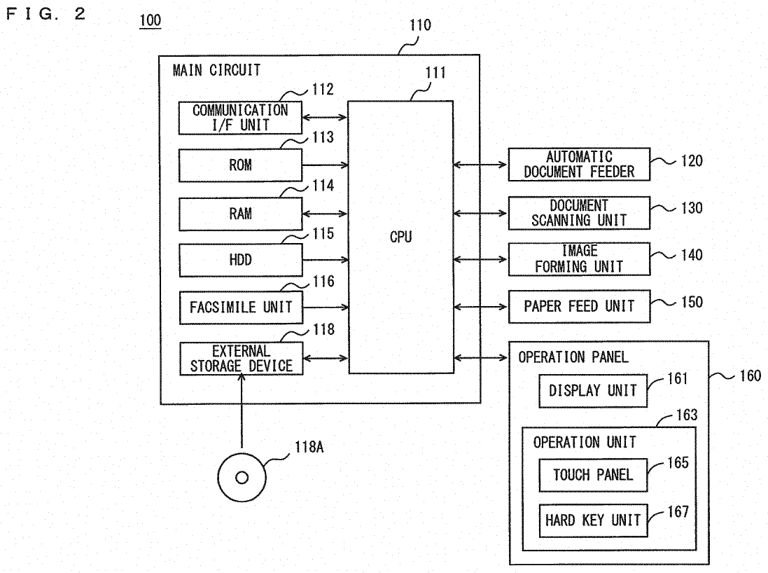

FIG. 1 is a perspective view showing the appearance of an MFP in a first embodiment of the present invention. FIG. 2 is a block diagram showing the outline of a hardware configuration of the MFP in the first embodiment. Referring to FIG. 1 and FIG. 2, the MFP (Multi Function Peripheral) 100 is one example of an image processing apparatus and includes a main circuit 110, a document scanning unit 130 for scanning a document, an automatic document feeder 120 for conveying a document to the document scanning unit 130, an image forming unit 140 for forming an image on a paper (a sheet of paper) based on image data, a paper feed unit 150 for supplying the paper to the image forming unit 140, and an operation panel 160 serving as a user interface.

The automatic document feeder 120 automatically conveys a plurality of documents set on a document tray 125 to a document scanning position of the document scanning unit 130 one by one, and discharges the document having an image that has been scanned by the document scanning unit 130 to a document discharge tray.

The document scanning unit 130 has a rectangular scan surface for scanning a document. The scan surface is formed of a platen glass, for example. The automatic document feeder 120 is connected to the main body of the MFP 100 to be rotatable about an axis in parallel to one edge of the scan surface and can be open or closed. The document scanning unit 130 is arranged below the automatic document feeder 120, and the scan surface of the document scanning unit 130 is exposed in an open state where the automatic document feeder 120 is opened after being rotated. Therefore, a user can place a document on the scan surface of the document scanning unit 130. The automatic document feeder 120 can change between an open state where the scan surface of the document scanning unit 130 is exposed and a close state where the scan surface is covered.

The image forming unit 140 forms an image on a paper conveyed by the paper feed unit 150 using a well-known electrophotographic method. In the present embodiment, the image forming unit 140 forms an image on the paper conveyed by the paper feed unit 150 according to an image forming condition corresponding to the image data and the medium type of the paper. The paper on which an image is formed is discharged to a paper discharge tray 159.

The main circuit 110 includes a CPU (Central Processing Unit) 111 that controls the MFP 100 as a whole, a communication interface (I/F) unit 112, a ROM (Read Only Memory) 113, a RAM (Random Access Memory) 114, a hard disk drive (HDD) 115 as a mass storage device, a facsimile unit 116 and an external storage device 118. The CPU 111 is connected to the automatic document feeder 120, the document scanning unit 130, the image forming unit 140, the paper feed unit 150 and the operation panel 160, and controls the MFP 100 as a whole.

The ROM 113 stores a program to be executed by the CPU 111 or data necessary for execution of the program. The RAM 114 is used as a work area when the CPU 111 executes the program. Further, the RAM 114 temporarily stores image data successively transmitted from the document scanning unit 130.

The operation panel 160 is provided in an upper part of the MFP 100. The operation panel 160 includes a display unit 161 and an operation unit 163. The display unit 161 is a Liquid Crystal Display (LCD), for example, and displays instruction menus to users, information about the acquired image data and other information. For example, an organic EL (Electroluminescence) display can be used instead of the LCD as long as the device displays images.

The operation unit 163 includes a touch panel 165 and a hard key unit 167. The touch panel 165 is a capacitance type. Not only the capacitance type but also another type such as a resistive film type, a surface acoustic wave type, an infrared type and an electromagnetic induction type can be used for the touch panel 165.

The detection surface of the touch panel 165 is provided to be superimposed on the upper surface or the lower surface of the display unit 161. Here, the size of the detection surface of the touch panel 165 is equal to the size of the display surface of the display unit 161. Thus, the coordinate system of the display surface and the coordinate system of the detection surface are the same. The touch panel 165 detects the position designated by the user in the display surface of the display unit 161 and outputs the coordinates of the detected position to the CPU 111. The coordinate system of the display surface and the coordinate system of the detection surface are the same, so that the coordinates output by the touch panel 165 can be replaced by the coordinates of the display surface.

The hard key unit 167 includes a plurality of hard keys. The hard keys are contact switches, for example. The touch panel 165 detects the position designated by the user in the display surface of the display unit 161. In the case where operating the MFP 100, the user is likely to be in an upright attitude. Thus, the display surface of the display unit 161, the operation surface of the touch panel 165 and the hard key unit 167 are arranged to face upward. This is for the purpose of enabling the user to easily view the display surface of the display unit 161 and easily give an instruction using the operation unit 163 with his or her finger.

The communication I/F unit 112 is an interface for connecting the MFP 100 to the network. The communication I/F unit 112 communicates with another computer connected to the network or a data processing device connected to the network using a communication protocol such as a TCP (Transmission Control Protocol) or an FTP (File Transfer Protocol). The network to which the communication I/F unit 112 is connected is a Local Area Network (LAN), either wired or wireless. Further, the network is not limited to the LAN and may be a Wide Area Network (WAN), a Public Switched Telephone Networks (PSTN), the Internet or the like.

The facsimile unit 116 is connected to the Public Switched Telephone Network (PSTN), and transmits facsimile data to or receives facsimile data from the PSTN. The facsimile unit 116 stores the received facsimile data in the HDD 115, converts the received facsimile data into print data that is printable in the image forming unit 140 and outputs the print data to the image forming unit 140. Thus, the image forming unit 140 forms the image represented by the facsimile data received from the facsimile unit 116 on a paper. Further, the facsimile unit 116 converts the data stored in the HDD 115 into facsimile data, and transmits the facsimile data to a facsimile machine connected to the PSTN.

The external storage device 118 is controlled by the CPU 111 and mounted with a CD-ROM (Compact Disk Read Only Memory) 118A or a semiconductor memory. While the CPU 111 executes the program stored in the ROM 113 by way of example in the present embodiment, the CPU 111 may control the external storage device 118, read out the program to be executed by the CPU 111 from the CD-ROM 118A and store the read program in the RAM 114 for execution.

The CPU 111 controls the image forming unit 140 and allows the image forming unit 140 to form an image of the image data on a recording medium such as a paper. The image data output by the CPU 111 to the image forming unit 140 includes image data such as externally received print data in addition to the image data received from the document scanning unit 130.

The recording medium for storing the program to be executed by the CPU 111 is not limited to the CD-ROM 118A. It may be a flexible disc, a cassette tape, an optical disc (MO (Magnetic Optical Disc)/MD (Mini Disc)/DVD (Digital Versatile Disc)), an IC card, an optical card, and a semiconductor memory such as a mask ROM or an EPROM (Erasable Programmable ROM). Further, the CPU 111 may download the program from the computer connected to the network and store the program in the HDD 115. Alternatively, the computer connected to the network may write the program in the HDD 115, and then the program stored in the HDD 115 may be loaded into the RAM 114 to be executed in the CPU 111. The program referred to here includes not only a program directly executable by the CPU 111 but also a source program, a compressed program, an encrypted program or the like.

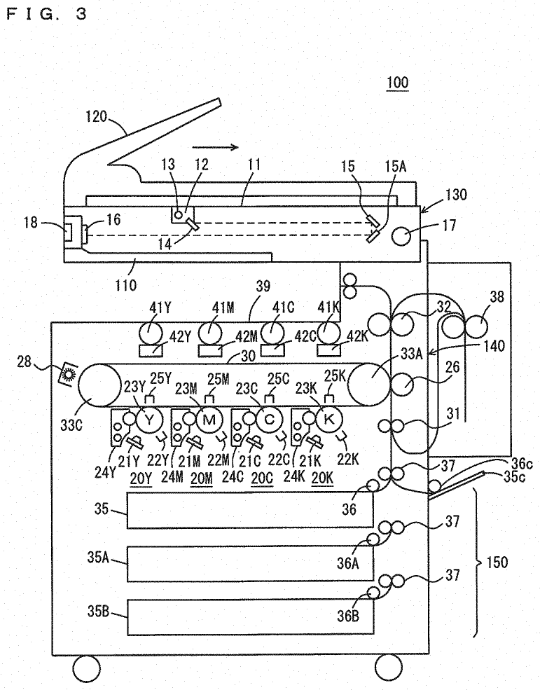

FIG. 3 is a schematic cross sectional view showing the inner configuration of the MFP in the first embodiment. Referring to FIG. 3, the automatic document feeder 120 sorts one or more documents placed on the document tray 125 and conveys the documents to the document scanning unit 130 one by one. The document scanning unit 130 exposes an image on a document set on a document glass 11 by the automatic document feeder 120 using an exposure lamp 13 attached to a slider 12 moving below. The light reflected from the document is led to a lens 16 by a mirror 14 and two reflection mirrors 15, 15A, and forms an image in a CCD (Charge Coupled Devices) sensor 18. The exposure lamp 13 and the mirror 14 are attached to the slider 12, and the slider 12 is moved by a scan motor 17 in the direction (a sub-scanning direction) indicated by an arrow in FIG. 3 at a speed V corresponding to a magnification ratio. Thus, the entire document set on the document glass 11 can be scanned. Further, the two reflection mirrors 15, 15A move in the direction indicated by the arrow in the FIG. 2 at a speed V/2 due to the movement of the exposure lamp 13 and the mirror 14. Thus, the optical path length of the light emitted to the document by the exposure lamp 13 from the position at which the light is reflected from the document to the position at which the light forms an image in the CCD sensor 18 is constant at all times.

The reflected light that has formed an image in the CCD sensor 18 is converted in the CCD sensor 18 into image data as an electric signal, and the image data is sent to the main circuit 110. After an A/D conversion process, a digital image process and the like are carried out on the received analogue image data, the main circuit 110 outputs the image data to the image forming unit 140. The main circuit 110 converts the image data into print data for cyan (C), magenta (M), yellow (Y) and black (K), and outputs the print data to the image forming unit 140.

The image forming unit 140 includes respective image forming units 20Y, 20M, 20C, 20K for respective yellow, magenta, cyan and black. Here, “Y,” “M,” “C” and “K” respectively represent yellow, magenta, cyan and black. At least one of the image forming units 20Y, 20M, 20C, 20K is driven, so that an image is formed. When all of the image forming units 20Y, 20M, 20C, 20K are driven, a full color image is formed. The print data for yellow, magenta, cyan and black are respectively input in the image forming units 20Y, 20M, 20C, 20K. The only difference among the image forming units 20Y, 20M, 20C, 20K is the color of toner handled by the image forming units 20Y, 20M, 20C, 20K. Here, the image forming unit 20Y for forming an image in yellow will be described.

The image forming unit 20Y includes an exposure head 21Y to which print data for yellow is input, a photoreceptor drum 23Y which is an image carrier, an electric charger 22Y, a developer 24Y, a transfer charger 25Y, a toner bottle 41Y and a toner hopper 43Y. The toner bottle 41Y stores a yellow toner. The toner bottle 41Y rotates while using a toner bottle motor as a drive source. Spiral projections are formed on the inner wall of the toner bottle 41Y. When the toner bottle 41Y rotates, the toner moves along the projections and is discharged to the outside of the toner bottle 41Y. The toner discharged from the toner bottle 41Y is supplied to the toner hopper 43Y. The toner hopper 43Y includes a storage chamber for storing toner, a screw provided in a lower part of the storage chamber and a toner replenish motor that rotates the screw. A connection member that is connected to the developer 24Y is attached to a position in the vicinity of the end of the screw of the storage chamber. When the toner replenish motor rotates the screw, the toner stored in the storage chamber moves along the screw, passes through the connection member and is supplied to the developer 24Y.

The exposure head 21Y emits light according to the print data (an electric signal) received from the main circuit 110 and exposes the photoreceptor drum 23Y which is an object to be exposed. The exposure head 21Y emits laser light according to the received print data (an electric signal). The emitted laser light is one-dimensionally scanned by a polygon mirror included in the exposure head 21Y and exposes the photoreceptor drum 23Y. The polygon mirror rotates while using a PC motor as a drive source. Further, the angle of the rotation axis of the polygon mirror is adjusted by a skew correction motor. The direction in which the exposure head 21Y one-dimensionally scans the photoreceptor drum 23Y is a main scanning direction. The skew correction motor is driven and the angle of the rotation axis of the polygon mirror is adjusted in order that the direction in which the exposure head 21Y one-dimensionally scans the photoreceptor drum 23Y coincides with the main scanning direction. The photoreceptor drum 23Y is a columnar, and is driven by a motor and rotates about a rotation axis in parallel to the sub-scanning direction. After being charged by the electric charger 22Y, the photoreceptor drum 23Y is irradiated with the laser light emitted by the exposure head 21Y. Thus, an electrostatic latent image is formed on the photoreceptor drum 23Y.

Subsequently, a toner image is formed on the photoreceptor drum 23Y by the developer 24Y. Specifically, the developer 24Y is driven by a development motor, and places the toner supplied from the toner hopper 43Y on the electrostatic latent image formed on the photoreceptor drum 23Y. The toner image formed on the photoreceptor drum 23Y is transferred onto an intermediate transfer belt 30 by the transfer charger 25Y. The transfer charger 25Y is switched between the state of being pressurized against the intermediate transfer belt 30 and the state of not being pressurized against the intermediate transfer belt 30 by a first transfer pressure clutch. The transfer charger 25Y is pressurized against the intermediate transfer belt 30 in the case where the first transfer pressure clutch is in an ON state, and is not pressurized against the intermediate transfer belt 30 in the case where the first transfer pressure clutch is in an OFF state.

On the other hand, the intermediate transfer belt 30 is suspended by a drive roller 33C and a roller 33A not to loosen. The drive roller 33C rotates while using a transport motor as a power source. When the drive roller 33C rotates in an anti-clockwise direction in FIG. 3, the intermediate transfer belt 30 rotates in the anti-clockwise direction in the diagram at a predetermined speed. The roller 33A rotates in the anti-clockwise direction as the intermediate transfer belt 30 rotates.

Thus, the image forming units 20Y, 20M, 20C, 20K sequentially transfer toner images onto the intermediate transfer belt 30. Timing for transferring toner images onto the intermediate transfer belt 30 by the image forming units 20Y, 20M, 20C, 20K is adjusted by detection of a reference mark applied to the intermediate transfer belt 30. Thus, toner images in yellow, magenta, cyan and black are superimposed on the intermediate transfer belt 30.

Papers in different sizes are respectively set in paper feed cassettes 35, 35A, 35B. The paper stored in the paper feed cassette 35 is lifted by a lift mechanism that uses a first-level cassette motor as a drive source, and is supplied to a transport path by an outlet roller 36. The paper stored in the paper feed cassette 35A is lifted by a lift mechanism that uses a second-level cassette motor as a drive source, and is supplied to the transport path by an outlet roller 36A. The paper stored in the paper feed cassette 35B is lifted by a lift mechanism that uses a third-level cassette motor as a drive source, and is supplied to a transport path by an outlet roller 36B.

The papers respectively stored in the paper feed cassettes 35, 35A, 35B are supplied to the transport path by the outlet rollers 36, 36A, 36B respectively attached to the paper feed cassettes 35, 35A, 35B, and then sent to a resist roller 31 by paper feed rollers 37. The paper feed rollers 37 are connected to the transport motor through a paper feed clutch and rotates while using the transport motor as a drive source. The rotational force of the transport motor is transmitted to any of the paper feed rollers 37 through the paper feed clutch. The paper feed clutch is controlled by the CPU 111 and changes to either one of a disconnected state and a connected state. In the case where the paper feed clutch is in the connected state, the rotational force of the transport motor is transmitted to any of the paper feed rollers 37. In the case where paper feed clutch is in the disconnected state, the rotational force of the transport motor is not transmitted to any of the paper feed rollers 37.

In the case where a paper is placed on a manual paper feed cassette 35C, an outlet roller 36C is pressed against the paper by a manual paper feed solenoid. The outlet roller 36C rotates while using the transport motor as a power source and supplies the paper to the transport path.

The resist roller 31 transports the paper conveyed by the paper feed roller 37, the outlet roller 36C or a double-side transport roller 38 that is described below to a transfer roller 26 such that the toner image formed on the intermediate transfer belt 30 arrives at the transfer roller 26 in a timely manner. The resist roller 31 is connected to the transport motor through a resist clutch, and rotates while using the transport motor as a power source. The rotational force of the transport motor is transmitted to the paper feed rollers 37 through the resist clutch. The resist clutch is controlled by the CPU 111 and changes to either one of the disconnected state and the connected state. In the case where the resist clutch is in the connected state, the rotational force of the transport motor is transmitted to the paper feed rollers 37. In the case where the resist clutch is in the disconnected state, the rotational force of the transport motor is not transmitted to the paper feed rollers 37.

The toner image formed on the intermediate transfer belt 30 is transferred to the paper by the transfer roller 26. The paper to which the toner image has been transferred is transported and heated by a pair of fuser rollers 32. Thus, the toner is fused and fixed to the paper. The pair of fuser rollers 32 rotates while using a fuser motor as a drive source. Further, a rotation axis of one of the pair of fuser rollers 32 is movable while using a pressure switch motor as a power source. Thus, the distance between the rotation axes of the pair of respective fuser rollers 32 is adjusted to the distance corresponding to the thickness of the paper. The paper that passes through the space between the pair of fuser rollers 32 is cooled by a paper cooling fan and discharged to the paper discharge tray 159. The paper cooling fan rotates while using a motor as a drive source.

Further, in case of a double-side print mode in which images are to be formed on the front side and back side of the paper, the paper transported through the transport path is guided to a double-side transport path after a toner image is fused and fixed on the front side by the pair of fuser rollers 32. A double-side transport roller 38 that rotates while using a double-side transport motor as a power source is provided in the double-side transport path. The double-side transport roller 38 rotates in a forward direction to transport the paper, and then rotates in a reverse direction to transport the paper. Thus, the paper that passes through the double-side transport path is transported to the resist roller 31 with the front and back sides inverted.

A removing device 28 is provided in the upstream of the image forming unit 20Y of the intermediate transfer belt 30. The removing device 28 removes the residual toner on the intermediate transfer belt 30. The toner collected by the removing device 28 is transported to a waste-toner bottle by a screw that rotates while using a waste-toner transport motor as a power source.

In the case where forming a full color image, the MFP 100 drives all of the image forming units 20Y, 20M, 20C, 20K. However, in the case where forming a monochrome image, the MFP 100 drives one of the image forming units 20Y, 20M, 20C, 20K. Further, the MFP 100 can form an image by a combination of two or more than two of the image forming units 20Y, 20M, 20C, 20K. While a tandem-system MFP 100 including the image forming units 20Y, 20M, 20C, 20K that respectively form images on a paper by using toner of four colors is described here, a four-cycle system MFP that sequentially transfers the toner of four colors to a paper using one photoreceptor drum may be used.

Further, the MFP 100 includes a power supply circuit that takes in the power supplied from a commercial power supply and supplies the power to each member and a power supply cooling fan for cooling the power supply circuit. The power supply cooling fan rotates while using a motor as a power source.

As one example of the members that drive as described above, the MFP 100 in the present embodiment includes the scan motor, the transport motor, the PC motor, the fuser motor, the development motor, the toner replenish motor, the toner bottle motor, the pressure switch motor, the waste-toner transport motor, the skew correction motor, the power supply cooling fan, the toner bottle cooling fan, the paper cooling fan, the paper feed clutch, the resist clutch, the first transfer pressure clutch, the first-level cassette motor, the second-level cassette motor, the third-level cassette motor, the manual paper feed solenoid and the double-side transport motor. These members are respectively connected to drive circuits that control these members. Each drive circuit includes an abnormality detection circuit that detects abnormality of the member to be controlled. The abnormality detection circuit outputs an abnormality signal indicating abnormality in the member.

In order to control the plurality of members respectively, the CPU 111 outputs a control signal to each drive circuit that controls the member to be controlled and allows the drive circuit to control the member. Further, in the case where abnormality is detected in any of the plurality of members, the CPU 111 detects the member having abnormality.

The MFP 100 includes a conversion circuit corresponding to the plurality of members to be controlled. The conversion circuit converts abnormality signals corresponding to a plurality of members into an integrated signal indicating abnormality in at least one of the plurality of members. The conversion circuit outputs the integrated signal to the CPU 111. When receiving the integrated signal from the conversion circuit, the CPU 111 detects abnormality in at least one of the plurality of members.

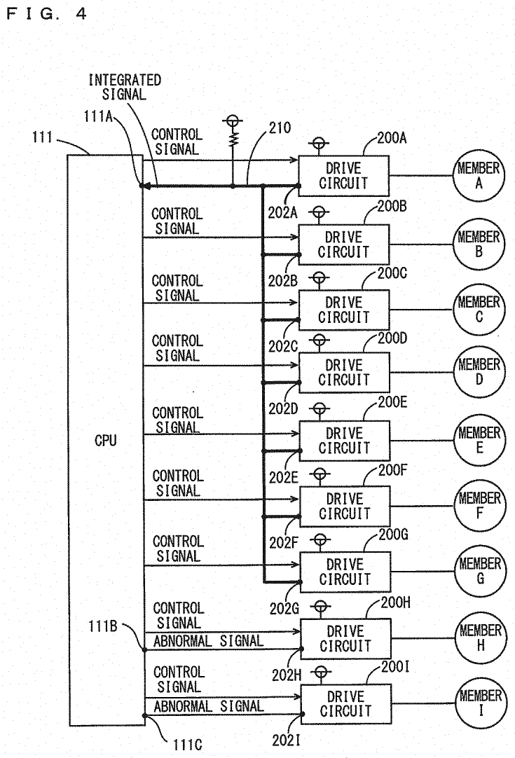

FIG. 4 is a diagram showing one example of the conversion circuit in the first embodiment. In FIG. 4, nine members A to G are connected to drive circuits 200A to 200I, respectively. The members A to G are normal members that are not prevented from driving in a standalone mode while an image processing operation is not being carried out. Members H and G are drive prevented members that are prevented in advance from driving in the standalone mode while the image processing operation is not being carried out.

The drive circuits 200A to 200I respectively include output terminals 202A to 202I that output abnormality signals. For example, the drive circuit 200A outputs an abnormality signal indicating abnormality in the member A to be controlled from the output terminal 202A. The drive circuit 200A makes the voltage of the output terminal 202A be high while abnormality in the member is being detected, and makes the voltage of the output terminal 202A be low while abnormality in the member is not being detected. Therefore, the abnormality signal is output from the output terminal 202A with the voltage of the output terminal 202A being high.

The conversion circuit 210 indicated by the thick lines in the diagram converts abnormality signals respectively output by the drive circuits 200A to 200G into an integrated signal indicating abnormality in at least one of the plurality of members A to G. The CPU 111 includes a first input terminal 111A to which an integrated signal is input, and a second input terminal 111B and a third input terminal 111C to which an abnormality signal is input. The conversion circuit 210 connects the respective output terminals 202A to 202G of the drive circuits 200A to 200G to the first input terminal 111A of the CPU 111. Therefore, in the case where the voltage of at least one of the output terminals 202A to 202G is high, the voltage of the first input terminal 111A becomes high. Further, in the case where the voltages of all of the output terminals 202A to 202G are low, the voltage of the first input terminal 111A becomes low. In this manner, an integrated signal is input to the first input terminal 111A with the voltage of the first input terminal 111A being high. Thus, the CPU 111 detects the integrated signal in the case where the voltage of the first input terminal 111A is high.

Further, the output terminal 202H of the drive circuit 200H is connected to the second input terminal 111B of the CPU 111. In the case where the voltage of the output terminal 202H is high, the voltage of the second input terminal 111B becomes high. Therefore, the CPU 111 detects an abnormality signal in the case where the voltage of the second input terminal 111B is high, and the CPU 111 can determine that the member H is abnormal. The output terminal 202I of the drive circuit 200I is connected to the third input terminal 111C of the CPU 111. In the case where the voltage of the output terminal 202I is high, the voltage of the third input terminal 111C becomes high. Therefore, the CPU 111 detects an abnormality signal in the case where the voltage of the third input terminal 111C is high, and the CPU 111 can determine that the member I is abnormal.

Further, the CPU 111 outputs control signals to the drive circuits 200A to 200I to which the members A to I are respectively connected in order to control the members A to I.

While the one conversion circuit 210 is shown in FIG. 4, the MFP 100 may include a plurality of conversion circuits 210.

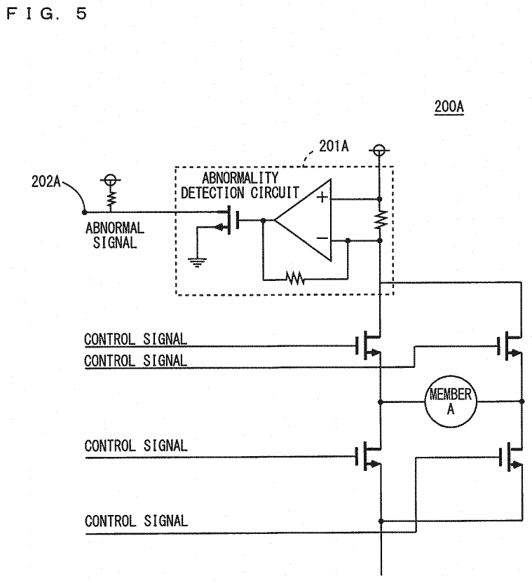

FIG. 5 is a diagram showing one example of a drive circuit. Here, the drive circuit 200A that controls the member A with the member A being a motor is taken as an example. Referring to FIG. 5, the drive circuit 200A controls a switch according to a control signal received from the CPU 111 and rotates the member A in the forward or reverse direction. Further, the drive circuit 200A includes an abnormality detection circuit 201A. The abnormality detection circuit 201A is configured such that, in the case where a current flowing through the member A exceeds a threshold value, the voltage of the output terminal 202A becomes high. Further, the abnormality detection circuit 201A is configured such that, in the case where a current stops flowing through the member A, the voltage of the output terminal 202A becomes low. Therefore, the abnormality detection circuit 201A makes the voltage of the output terminal 202A be high continuously while the current flowing through the member A is exceeding the threshold value. In other words, in the case where the member A to be controlled becomes abnormal, the drive circuit 200A outputs an abnormality signal continuously while the member A to be controlled is being driven.

The abnormality detection circuit 201A detects an overcurrent flowing through the member A. However, a circuit that measures the temperature of the member A may be provided separately or additionally, and the abnormal detection circuit 201A may be configured such that, in the case where the temperature of the member A exceeds a predetermined threshold value, the voltage of the output terminal 202A becomes high. Further, the drive circuits 200B to 200I can have the configuration similar to that of the drive circuit 200A.

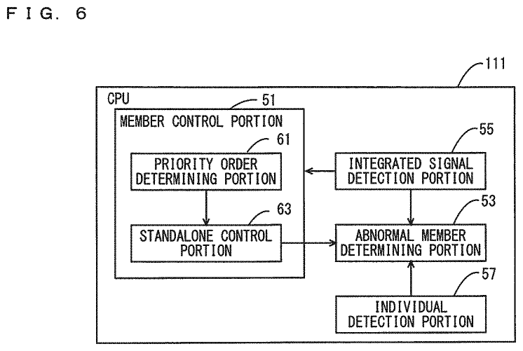

FIG. 6 is a block diagram showing one example of functions of the CPU included in the MFP in the first embodiment. The functions of the CPU 111 shown in FIG. 6 are realized by the CPU 111 when the CPU 111 included in the MFP 100 executes an abnormality detection program stored in the ROM 113, the HDD 115 or the CD-ROM 118A. Here, an integrated signal is input to the first input terminal 111A of the CPU 111 by the conversion circuit 210 shown in FIG. 4, by way of example.

Referring to FIG. 6, the CPU 111 includes a member control portion 51, an abnormal member determining portion 53, an integrated signal detection portion 55 and an individual detection portion 57. The member control portion 51 controls the plurality of members A to I using control signals including a start signal for giving an instruction for starting the drive and an end signal for giving an instruction for ending the drive. Specifically, the member control portion 51 outputs the control signals to the drive circuits 200A to 200I to which the plurality of members A to I are respectively connected in order to respectively control the plurality of members A to I.

The integrated signal detection portion 55 monitors the first input terminal 111A and detects an integrated signal. An integrated signal is input to the first input terminal 111A from the conversion circuit 210 as shown in FIG. 6.

The individual detection portion 57 monitors the second input terminal 111B and the third input terminal 111C, and detects abnormality signals. The individual detection portion 57 detects the abnormality signal when the voltage of the second input terminal 111B becomes high, and determines the member H as an abnormal member having abnormality. The individual detection portion 57 detects the abnormality signal when the voltage of the third input terminal 111C becomes high, and determines the member I as an abnormal member having abnormality. In the case where determining one of the members H and I as an abnormal member, the individual detection portion 57 outputs the member identification information of the abnormal member to the abnormal member determining portion 53.

The member control portion 51 includes a priority order determining portion 61 and a standalone control portion 63. The priority order determining portion 61 determines the priority order of the plurality of members. Here, the priority order determining portion 61 determines the priority order based on the cumulative drive time, which is the accumulation of the time during which each member is driven, such that the longer the cumulative drive time is, the higher the priority order is.

The standalone control portion 63 allows the plurality of members to be driven in the standalone mode according to the priority order. The standalone control portion 63 selects one of the members A to Gin the order of descending cumulative drive time and allows the selected member to be driven in the standalone mode.

In response to detection of an integrated signal by the integrated signal detection portion 55, the abnormal member determining portion 53 determines an abnormal member having abnormality from among the members A to G. Specifically, in the case where an integrated signal is detected by the integrated signal detection portion 55 while the standalone control portion 63 is allowing one of the members A to G to be driven in the standalone mode, the abnormal member determining portion 53 determines the member being driven in the standalone mode as an abnormal member. In the case where an integrated signal is not detected by the integrated signal detection portion 55 while the standalone control portion 63 is allowing one of the members A to G to be driven in the standalone mode, the abnormal member determining portion 53 does not determine the member being driven in the standalone mode as an abnormal member. In the case where determining an abnormal member, the abnormal member determining portion 53 notifies the user of an occurrence of abnormality in the abnormal member. Specifically, the abnormal member determining portion 53 displays the member identification information for identifying the abnormal member in the display unit 161.

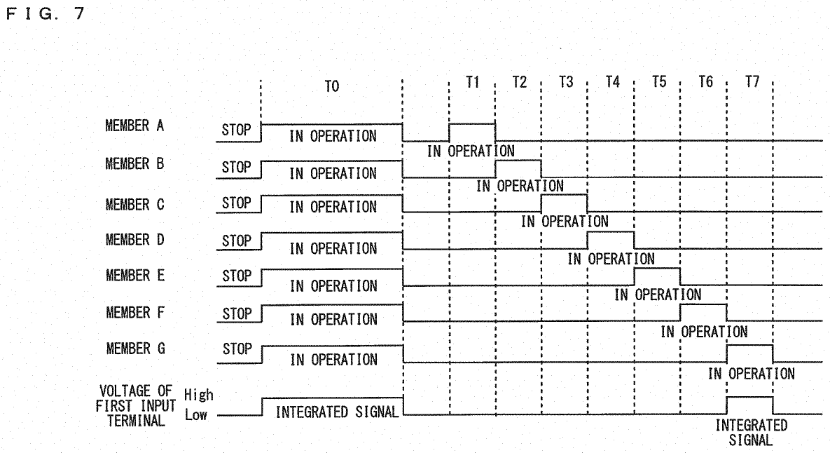

FIG. 7 is a diagram showing one example of operation states of the members A to G and an integrated signal. The abscissa of FIG. 7 indicates a time flow. A period T0 indicates the period during which an image processing operation is carried out. Here, the members A to G are respectively driven in the period T0. After the period T0, the members A and G are sequentially and respectively driven in the periods T1 to T7. The voltage of the first input terminal 111A of the CPU 111 is high in the period T0 and period T7, and low in other periods. Thus, the integrated signal is detected in the period T0 and the period T7. In the period T7, only the member G is driven, so that the member G can be determined as being abnormal.

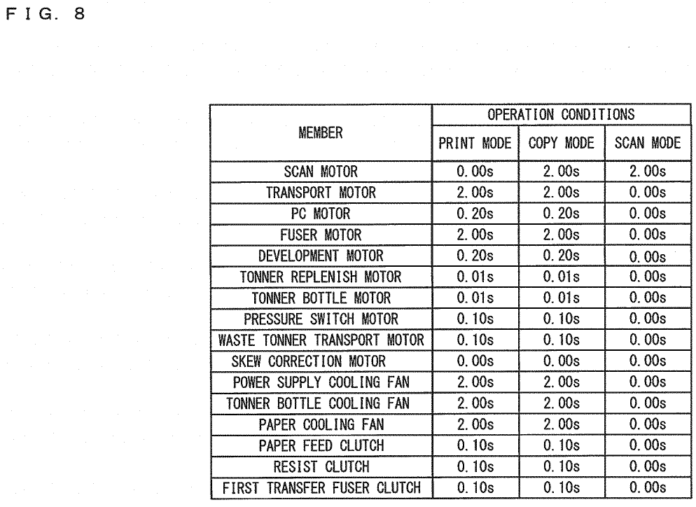

FIG. 8 is a diagram showing one example of a unit drive time table. Referring to FIG. 8, the unit drive time table shows a unit drive time of each of the plurality of members in the case where the image process is carried out according to the respective operation conditions including a print mode, a copy mode and a scan mode. The unit drive time indicates the time during which each member is driven while an image process is being carried out once according to each operation condition.

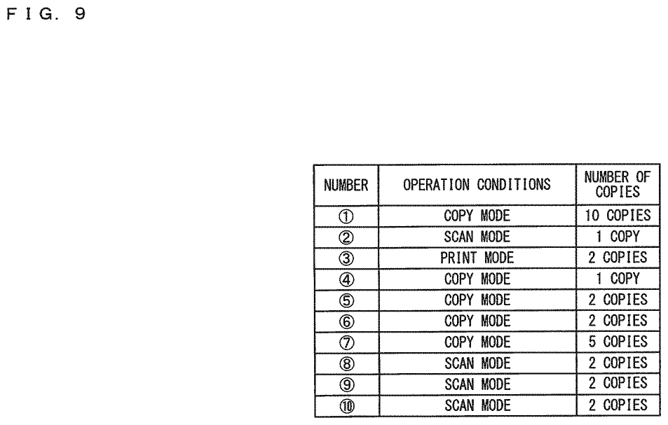

FIG. 9 is a diagram showing one example of an operation history table. Referring to FIG. 9, the operation history table includes a plurality of history records. A history record is added to the operation history table each time an image process is carried out according to one of the above-mentioned operation conditions. The history record includes a field for numeric numbers, a field for the operation conditions and a field for the numbers of copies. The field for the numeric numbers shows the information for identifying the image processes that are carried out respectively according to the above-mentioned operation conditions. The field for the operation conditions shows the operation conditions of the image processes. The field for the numbers of copies shows the numbers of times the image processes are carried out.

The cumulative drive time of each member can be calculated from the operation history and the unit drive time of the member. Specifically, the operation condition and the number of times an image process is carried out are defined in each history record, so that the drive time of each of the plurality of members is obtained in each history record. The drive time of each of the plurality of members obtained in each of the plurality of history records is integrated, whereby the cumulative drive time of each of the plurality of members is calculated. The cumulative drive time of each of the plurality of members may be obtained by calculation of the cumulative drive time of each of the plurality of members.

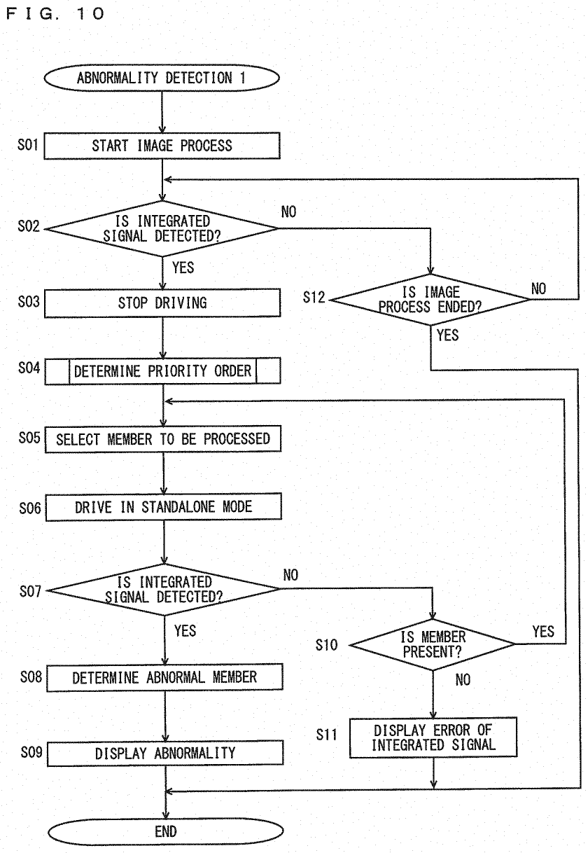

FIG. 10 is a flow chart showing one example of a flow of an abnormality detection process. The abnormality detection process is carried out by the CPU 111 when the CPU 111 included in the MFP 100 executes an abnormality detection processing program stored in the ROM 113, the HDD 115 or the CD-ROM 118A. Referring to FIG. 10, the CPU 111 starts an image process (step S01A). Specifically, the CPU 111 determines a drive start time point at which driving of each of the members A to I is started and a drive stop time point at which driving of each of the members A to I is stopped in order to carry out the image process defined by a user's operation of inputting in the operation unit 163. Then, the CPU 111 controls the members A to G based on the drive start time point and the drive stop time point defined with respect to each of the members A to I. For example, when the current time is the drive start time point determined with respect to the member A, the CPU 111 outputs a control signal for giving an instruction for starting the drive to the drive circuit to which the member A is connected. Further, when the current time is the drive end time point determined with respect to the member A, the CPU 111 outputs a control signal for giving an instruction for stopping the drive to the drive circuit to which the member A is connected.

The CPU 111 determines whether an integrated signal has been detected (step S02). When the voltage of the first input terminal 111A is high, an integrated signal is detected. If the CPU 111 detects an integrated signal, the process proceeds to the step S03. If not, the process proceeds to the step S12. In the step S12, the CPU 111 determines whether the image process started in the step S01A has ended. If the image process has ended, the process ends. If not, the process returns to the step S02.

In the step S03, the driving of the members A to I is stopped, and the process proceeds to the step S04. In the step S04, the CPU 111 carries out the priority order determining process, and the process proceeds to the step S05. The priority order determining process, which will be described below in detail, is the process of determining the priority order of each of the plurality of members A to I.

In the step S05, the CPU 111 selects one of the members A to I as a member to be driven in the standalone mode, and the process proceeds to the step S06. In the step S06, the selected member is driven in the standalone mode, and the process proceeds to the step S07. In the step S07, the CPU 111 determines whether an integrated signal has been detected. When the voltage of the first input terminal 111A is high, an integrated signal is detected. If the CPU 111 has detected an integrated signal, the process proceeds to the step S08. If not, the process proceeds to the step S10.

In the step S08, the CPU 111 determines the member that is driven in the standalone mode in the step S06 as an abnormal member, and the process proceeds to the step S09. Then, abnormality is displayed (step S09), and the process ends. The member identification information for identifying the member that is determined as the abnormal member from among the members A to Gin the step S08 is displayed in the display unit 161. Thus, a service person who is in charge of repairing the MFP 100 can be notified of the abnormal member having abnormality. Thus, the service person can immediately perform an operation such as replacing the abnormal member. The CPU 111 determines the member H as an abnormal member at the time point at which the voltage of the second input terminal 111B becomes high, and displays the member identification information of the member H in the display unit 161. Further, the CPU 111 determines the member I as an abnormal member at the time point at which the voltage of the third input terminal 111C becomes high, and displays the member identification information of the member I in the display unit 161.

In the step S10, the CPU 111 determines whether the member that is not selected in the step S05 as a member to be driven in the standalone mode is present. If an unselected member is present, the process returns to the step S05. If not, the process proceeds to the step S11. In the step S11, the display unit 161 displays an error of the integrated signal detected in the step S02, and the process ends.

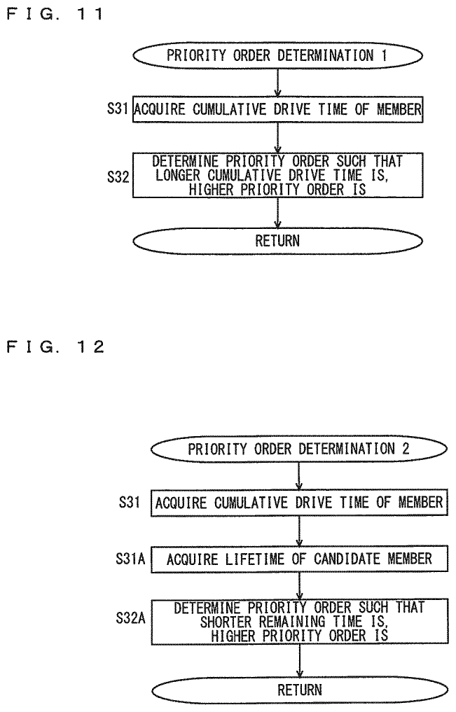

FIG. 11 is a flow chart showing one example of a flow of the priority order determining process. The priority order determining process is the process carried out in the step S04 of FIG. 10. Referring to FIG. 11, the CPU 111 acquires the cumulative drive time of each of the plurality of members A to G (step S31), and the process proceeds to the step S32. In the step S32, the CPU 111 determines the priority order of each of the plurality of members A to G based on the cumulative drive time such that the longer the cumulative drive time is, the higher the priority order is. Then, the process returns to the abnormality detection process.

### First Modified Example

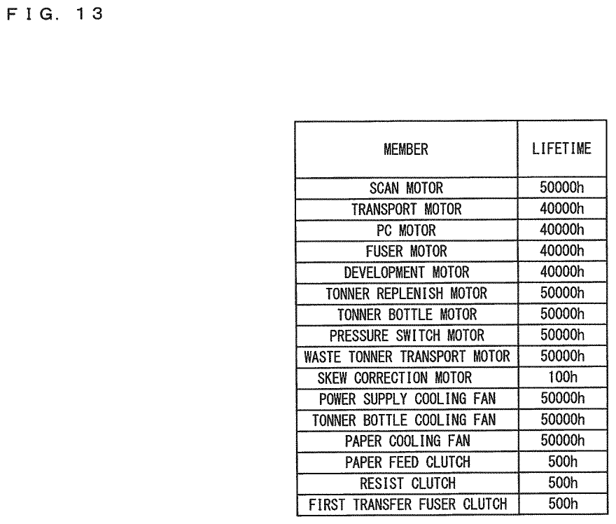

FIG. 12 is a flow chart showing one example of a flow of a priority order determining process in a first modified example. The priority order determining process in the first modified example is the process carried out in the step S04 of FIG. 10. Referring to FIG. 12, the CPU 111 acquires the cumulative drive time of each of the plurality of members A to G (step S31), and the process proceeds to the step S31A. In the step S31A, the lifetime of each of the plurality of members A to G is acquired, and the process proceeds to the step S32A. In the step S32A, the CPU 111 determines the priority order of each of the plurality of members A to G based on the remaining time such that the shorter the remaining time is, the higher the priority order is. Then, the process returns to the abnormality detection process. The remaining time is the value that is obtained by subtraction of the cumulative drive time from the lifetime.

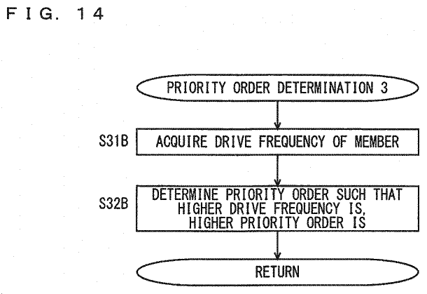

FIG. 13 is a diagram showing one example of a remaining time table. Referring to FIG. 13, the remaining time table defines the lifetime of each of the plurality of members.

### Second Modified Example

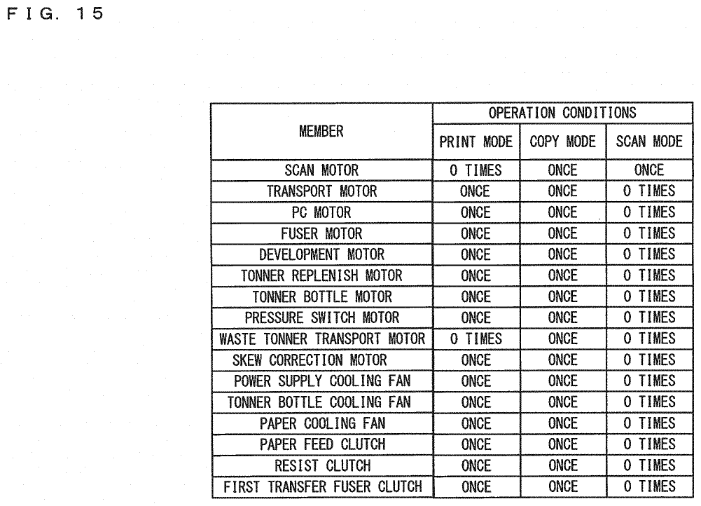

FIG. 14 is a flow chart showing one example of a flow of a priority order determining process in a second modified example. The priority order determining process in the second modified example is the process carried out in the step S04 of FIG. 10. Referring to FIG. 14, the CPU 111 acquires the drive frequency of each of the plurality of members A to G (step S31B), and the process proceeds to the step S32B. In the step S32B, the CPU 111 determines the priority order of each of the plurality of members A to G based on the drive frequency such that the higher the drive frequency is, the higher the priority order is. Then, the process returns to the abnormality detection process.

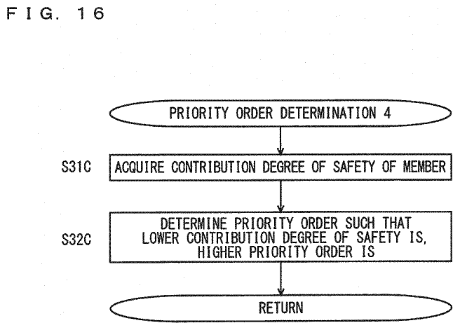

FIG. 15 is a diagram showing one example of a drive frequency table. Referring to FIG. 15, the driving frequency table shows the number of times each of the plurality of members is driven in one image process according to each of the operation conditions; the print mode, the copy mode and the scan mode.

The cumulative drive frequency can be calculated for each member from the operation history defined by the operation history table shown in FIG. 9 and the number of times each member is driven, the number of times being defined by the drive frequency table. Specifically, the operation condition and the number of times the image process is carried out are defined in each history record, so that the number of times each of the plurality of members is driven is obtained in each history record. The drive frequency obtained in each record is integrated for each member, so that the cumulative drive frequency of each member is calculated. The cumulative number of times each member is driven may be calculated, so that the drive frequency of each member is obtained.

### Third Modified Example

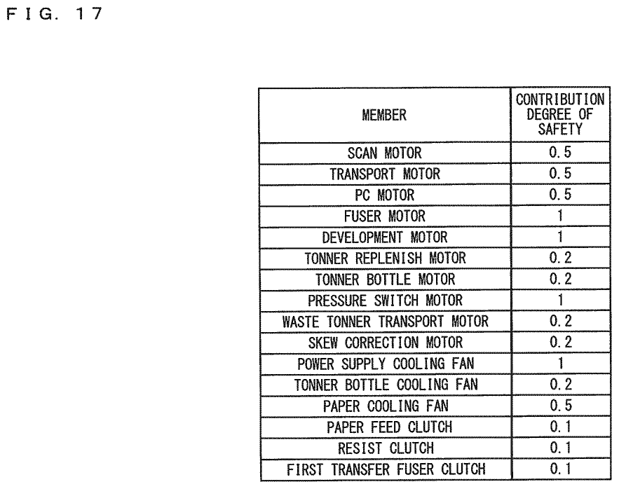

FIG. 16 is a flow chart showing one example of a flow of a priority order determining process in a third modified example. The priority order determining process in the third modified example is the process carried out in the step S04 of FIG. 10. Referring to FIG. 16, the CPU 111 acquires a contribution degree of safety of each of the plurality of members A to G (step S31C), and the process proceeds to the step S32C. In the step S32C, the CPU 111 determines the priority order of the plurality of members A to G based on the contribution degree of safety such that the higher the contribution degree of safety is, the higher the priority order is. Then, the process returns to the abnormality detection process. The contribution degree of safety is the value indicating the degree of safety of a member. The safer the member is to be driven, the higher the value is.

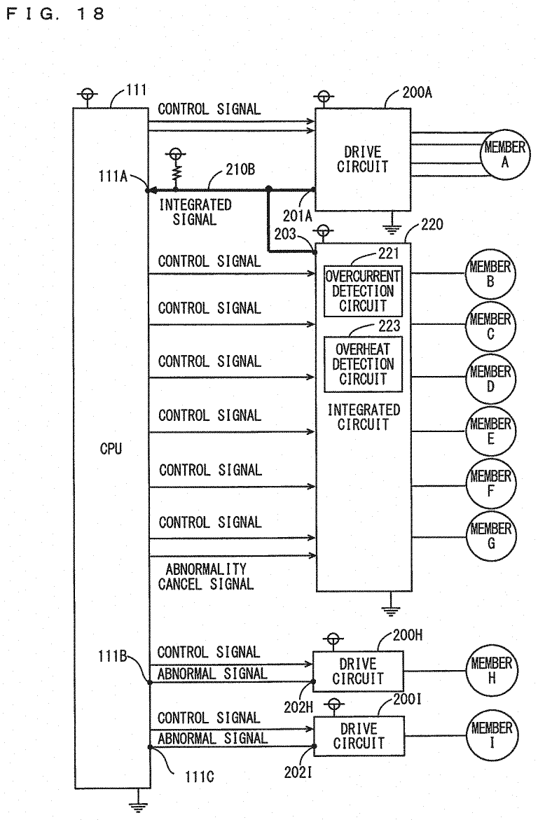

FIG. 17 is a diagram showing one example of a table of contribution degree of safety. Referring to FIG. 17, the safety contribution degree table respectively defines the contribution degree of safety for each of the plurality of members.

### Fourth Modified Example

The priority order is determined based on the cumulative drive time in the first embodiment, is determined based on the remaining time in the first modified example, is determined based on the drive frequency in the second modified example, and is determined based on the contribution degree of safety in the third modified example. The priority order may be determined based on a combination of two or more than two of the cumulative drive time, the remaining time, the drive frequency and the contribution degree of safety. Using the assessment value that is common among the above, the CPU 111 may determine the priority order based on the total assessment value such that the higher the assessment value is, the higher the priority order is.

### Fifth Modified Example

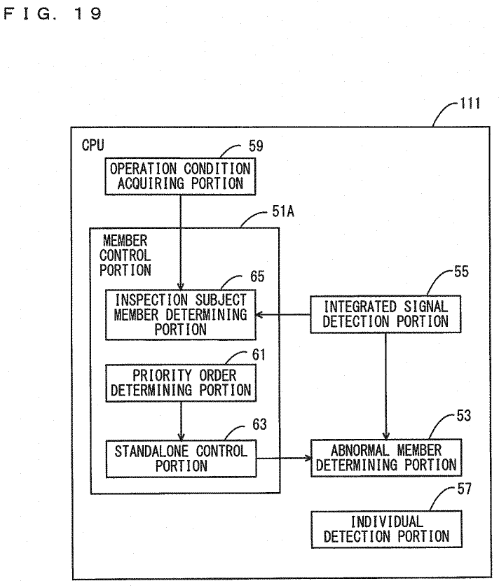

FIG. 18 is a diagram showing one example of a conversion circuit in a fifth modified example. Referring to FIG. 15, the difference from FIG. 4 is that an integrated circuit 220 controlling the members B to G is added. In the fifth modified example, the member A is a motor, and each of the members B to G is a solenoid or a clutch.

The integrated circuit 220 controls the members B to G respectively according to a control signal received from the CPU 111. The integrated circuit 220 includes an overcurrent detection circuit 221 and an overheat detection circuit 223. The overcurrent detection circuit 221 is configured to make the voltage of an output terminal 203 be high in the case where an overcurrent flows through any of the members B to G. Further, the overheat detection circuit 223 is configured to make the voltage of the output terminal 203 be high when the temperature of any of the members B to G becomes equal to or higher than a threshold value.

A conversion circuit 210B indicated by the thick lines in the diagram converts abnormality signals respectively output by a drive circuit 200A and an integrated circuit 220 into an integrated signal indicating abnormality in at least one of the plurality of members A to G. The conversion circuit 210B connects an output terminal 201A of a drive circuit 200A to a first input terminal 111A of the CPU 111, and connects an output terminal 203 of the integrated circuit 220 to the first input terminal 111A of the CPU 111. Therefore, in the case where the voltage of at least one of the output terminal 201A of the drive circuit 200A and the output terminal 203 of the integrated circuit 220 is high, the voltage of the first input terminal 111A becomes high. Further, in the case where the voltages of all of the output terminal 201A of the drive circuit 200A and the output terminal 203 of the integrated circuit 220 are low, the voltage of the first input terminal 111A becomes low. In this manner, in the case where at least one of the drive circuit 200A and the integrated circuit 220 outputs an abnormality signal, the conversion circuit 210B inputs an integrated signal to the first input terminal 111A. Therefore, the CPU 111 detects the integrated signal in the case where the voltage of the first input terminal 111A is high.

As described above, the MFP 100 in the first embodiment controls the drive prevented members and the members A to G, which are the plurality of normal members and are different from the drive prevented members, sequentially drives the members A to G after an integrated signal is detected, and determines an abnormal member having abnormality in the case where the integrated signal is detected with one of the members A to G being driven. Therefore, it is possible to determine an abnormal member without driving the drive prevented members in the standalone mode. One of the members A to G is driven after an integrated signal is detected, and presence or absence of an integrated signal is determined. Thus, the CPU 111 may include the first input terminal 111A to which an integrated signal is input from the conversion circuit 210. Therefore, the number of first input terminals 111A of the CPU 111 can be reduced, the circuit structure can be simplified, and the cost can be reduced.

Further, because detecting abnormality in the drive prevented members, the MFP 100 can detect abnormality in the drive prevented members during an image forming operation.

### Sixth Modified Example

The MFP 100 in the first embodiment sequentially drives all of the members A to G, which are the normal members, in the standalone mode. Therefore, the maximum value of the number of times the members A to G are driven in the standalone mode after the image processing operation is carried out is the same as the number of members, which is eight. In the sixth modified example, the number of the normal members to be driven in the standalone mode is reduced, and the number of times the member is driven after the image processing operation is carried out is reduced as much as possible. As for the MFP 100 in the sixth modified example, the differences from the MFP 100 in the first embodiment are mainly described.

FIG. 19 is a block diagram showing one example of functions of a CPU included in an MFP in the sixth modified example. The differences of the functions of the CPU 111 shown in FIG. 19 from the functions of the CPU 111 shown in FIG. 6 are that an operation condition acquiring portion 59 and an inspection subject member determining portion 65 are added. The other functions are the same as the functions shown in FIG. 6.

The operation condition acquiring portion 59 acquires an operation condition of an image process. An operation condition is defined by a user's operation of inputting in the operation unit 163. For example, the operation conditions of the image process include a copy mode in which a copy process is carried out, a scan mode in which a scan process is carried out, a print mode in which a print process is carried out, and a FAX mode in which a facsimile transmission reception process of transmitting and receiving facsimile data is carried out. Further, the operation condition may be defined by a user's operation of inputting in the operation unit 163. For example, the operation conditions may include an operation condition of an ADF copy mode in which the automatic document feeder 120 is utilized during the copy mode, an operation condition of a normal copy mode in which the automatic document feeder 120 is not utilized during the copy mode, an operation condition of a single-side print mode in which an image is formed on one side of a paper, and an operation condition of a double-side print mode in which images are formed on both sides of a paper. Further, the operation conditions may include an operation condition of a power saving mode in which power consumption is smaller or an operation condition of a start-up mode. The start-up mode is the operation mode in which the members A to I are getting ready to carry out operations of an image process after the MFP 100 is powered on.

The inspection subject member determining portion 65 determines a member, among the members A to G, that is to be driven in the case where an image processing operation is carried out according to the operation condition acquired by the operation condition acquiring portion 59 as an inspection subject member (a member to be inspected).

A standalone control portion 63 selects members in the order of descending priority from among one or more members that are determined as inspection subject members by the inspection subject member determining portion 65, and respectively drives the selected members in the standalone mode.

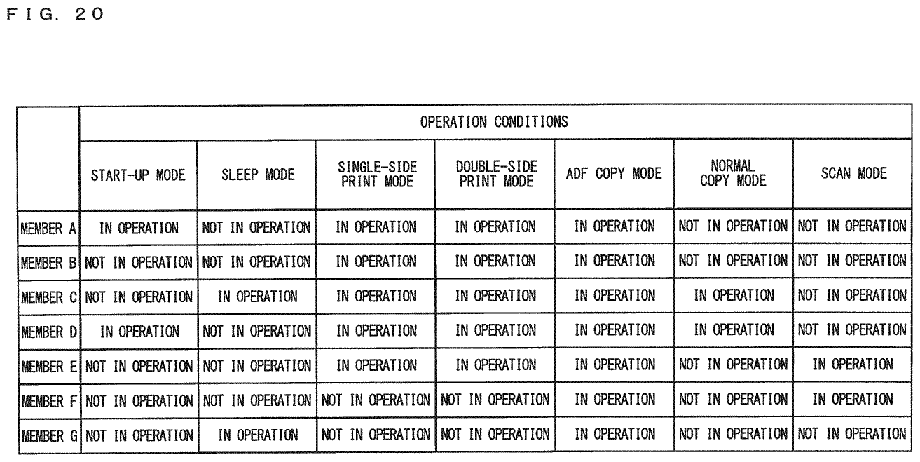

FIG. 20 is a diagram showing one example of an operation state table. Referring to FIG. 20, the operation state table shows the drive state of each of the plurality of members in regards to each operation condition. Specifically, the operation state table shows whether each of the members A to G is driven in regards to each of the plurality of operation conditions. For example, as for the operation condition of the start-up mode, the members A and D are in operation but the members B, C, E to G are not in operation. Further, as for the operation condition of a sleep mode, the member C and G are in operation but the member A, B, D to F are not in operation.

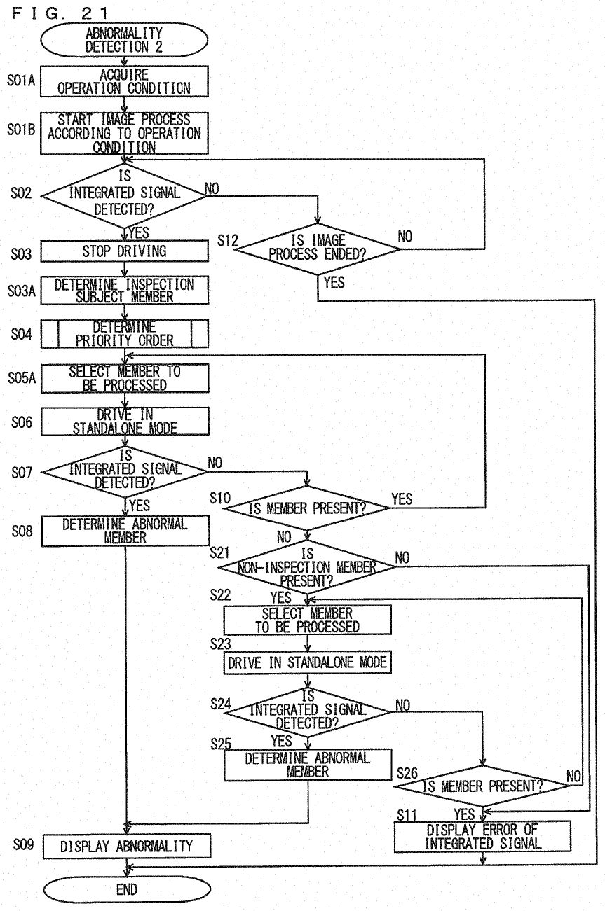

FIG. 21 is a flow chart showing one example of a flow of an abnormality detection process in the sixth modified example. Referring to FIG. 21, the differences from the abnormality detection process in the first embodiment shown in FIG. 10 are that the step S01A is changed to the step S01A and the step S01B, the step S03A is added between the step S03 and the step S04, the step S05 is changed to the step S05A, and the steps S21 to S26 are added between the step S10 and the step S11. The other processes are the same as the processes shown in FIG. 10. Therefore, a description thereof will not be repeated.

The CPU 111 acquires an operation condition for execution of an image process in the step S01A. The CPU 111 acquires the operation condition input by a user in the operation unit 163. In the next step S01B, the image process starts according to the operation condition acquired in the step S11, and the process proceeds to the step S02. In the step S02, if an integrated signal is detected, the process proceeds to the step S03A. If not, the process proceeds to the step S12. In the step S03, the CPU 111 stops driving the members A to I, and the process proceeds to the step S03A.

In the step S03A, the CPU 111 determines inspection subject members, and the process proceeds to the step S04. Specifically, the CPU 111 determines members, among the members A to G, that are driven while an image processing operation is being carried out according to the operation condition acquired in the step S01A as the inspection subject members. For example, the CPU 111 determines the inspection subject members using the operation state table shown in FIG. 20. In the step S04, the CPU 111 determines the priority order, and the process proceeds to the step S05A. In the step S05A, the CPU 111 selects one, of the plurality of members determined as the inspection subject members out of the members A to G, as a member to be processed, and the process proceeds to the step S06.

In the step S10, in the case where an integrated signal is not detected even when all of the inspection subject members are driven in the standalone mode, the process proceeds to the step S21. In the step S21, the CPU 111 determines whether a non-inspection member, among the members A to G, that is not determined as an inspection subject member is present. If a non-inspection member is present, the process proceeds to the step S22. If not, the process proceeds to the step S11.

In the step S22, the CPU 111 selects one from among one or more non-inspection members as a member to be processed, and the process proceeds to the step S23. In the step S23, the CPU 111 drives the non-inspection member selected as the member to be processed in the standalone mode, and the process proceeds to the step S24. In the step S24, the CPU 111 determines whether an integrated signal is detected. If the integrated signal is detected, the process proceeds to the step S25. If not, the process proceeds to the step S26. In the step S25, the CPU 111 determines the non-inspection member selected as the member to be processed as an abnormal member, and the process proceeds to the step S09. In the step S26, the CPU 111 determines whether an unselected non-inspection member is present. If an unselected non-inspection member is present, the process returns to the step S22. If not, the process proceeds to the step S11.

Because the MFP 100 in the sixth modified example determines two or more normal members as inspection subject members based on the operation conditions, if the operation condition indicates presence of a normal member that is not to be driven, the number of inspection subject members is small. Therefore, the time required for specifying an abnormal member can be shortened.

All of the normal members, among the plurality of normal members, that are driven while an image processing operation is being carried out and an integrated signal is being detected may be set as inspection subject members. Further, all of the normal members that are not driven while an integrated signal is being detected may be not set as inspection subject members. In this case, the number of inspection subject members can be reduced, so that the time required for specifying an abnormal member can be shortened.

### Second Embodiment

In the first embodiment, the MFP 100 sequentially drives the members A to G, which are the normal members, in the standalone mode. Therefore, the maximum value of the number of times the members A to G are driven in the standalone mode after an image processing operation is carried out is the same as the number of members, which is eight. In a second embodiment, one or more members are driven in parallel after an image processing operation is carried out, so that the number of times the members are driven is reduced. As for the MFP 100 in the second embodiment, the differences from the MFP 100 in the first embodiment will be mainly described.

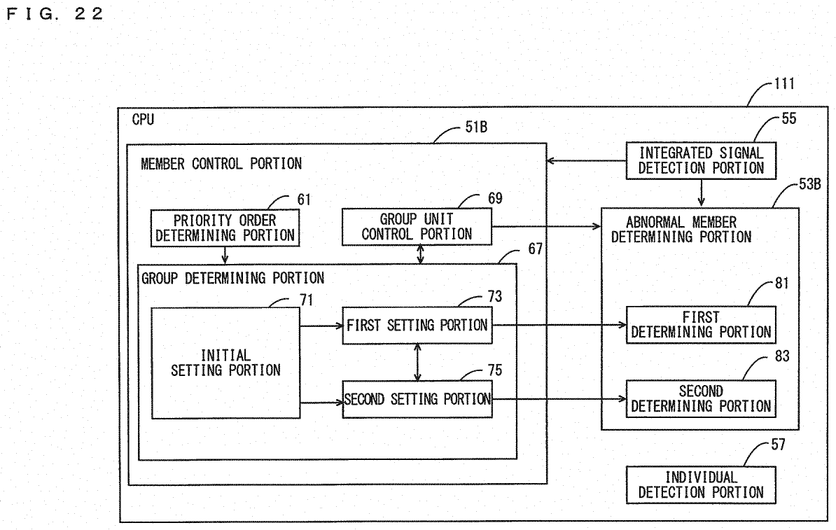

FIG. 22 is a block diagram showing one example of functions of a CPU included in an MFP in the second embodiment. Referring to FIG. 22, the differences from the functions of the CPU 111 in the first embodiment shown in FIG. 6 are that the member control portion 51 and the abnormal member determining portion 53 are respectively changed to a member control portion 51B and an abnormal member determining portion 53B. Other functions are the same as the functions shown in FIG. 6. Therefore, a description thereof will not be repeated.

The member control portion 51B includes a priority order determining portion 61, a group determining portion 67 and a group unit control portion 69. The group determining portion 67 includes an initial setting portion 71, a first setting portion 73 and a second setting portion 75. In the case where an integrated signal is detected during an image processing operation, the initial setting portion 71 sets all of a plurality of members A to G as new inspection subject members.

The group determining portion 67 classifies the plurality of members that are set as the inspection subject members into a first group and a second group. In the case where the number of the plurality of members that are set as the inspection subject members is an even number, the group determining portion 67 makes the number of the plurality of members classified into the first group be the same number as the number of the plurality of members classified into the second group. In the case where the number of the plurality of members that are set as the inspection subject members is an odd number, the group determining portion 67 makes the number of the plurality of members classified into the first group be larger than the number of the plurality of members classified into the second group by one. The group determining portion 67 classifies the plurality of members that are set as the inspection subject members into the first group in the order of descending priority.

The group unit control portion 69 allows the one or more members classified into the first group by the group determining portion 67 to be driven in parallel after an image processing operation is carried out.

In the case where an integrated signal is detected while the one or more members classified into the first group are being driven in parallel, the first setting portion 73 sets all of the one or more members that belong to the first group as new inspection subject members. In the case where an integrated signal is not detected while the one or more members classified into the first group are being driven in parallel, the second setting portion 75 sets all of the one or more members that belong to the second group as new inspection subject members.

The group determining portion 67 classifies the plurality of members that are set as the new inspection subject members by the first setting portion 73 or the second setting portion 75 into a first group and a second group. Each time a plurality of members set as new inspection subject members by the group determining portion 67 are classified into a first group and a second group, the group unit control portion 69 allows the one or more members classified into the first group to be driven in parallel.

The abnormal member determining portion 53B includes a first determining portion 81 and a second determining portion 83. In the case where one inspection subject member belongs to a first group, when an integrated signal is detected while the one inspection subject member that belongs to the first group is being driven, the first determining portion 81 determines the one inspection subject member that belongs to the first group as an abnormal member. In the case where one inspection subject member belongs to a second group, when an integrated signal is not detected while one or more inspection subject members that belong to a first group are being driven, the second determining portion 83 determines the one inspection subject that belongs to the second group as an abnormal member.

In the case where determining an abnormal member, the abnormal member determining portion 53A notifies the user of an occurrence of abnormality in the abnormal member. Specifically, the abnormal member determining portion 53A displays the member identification information for identifying the abnormal member in the display unit 161.

The members that are set as inspection subject members by the initial setting portion 71 may be all of the members that are driven while an image processing operation is being carried out according to an operation condition similarly to the MFP 100 in the sixth modified example. Further, the members that are set as inspection subject members by the initial setting portion 71 may be all of the members that are driven at the time point at which an integrated signal is detected while an image processing operation is being carried out according to an operating condition.

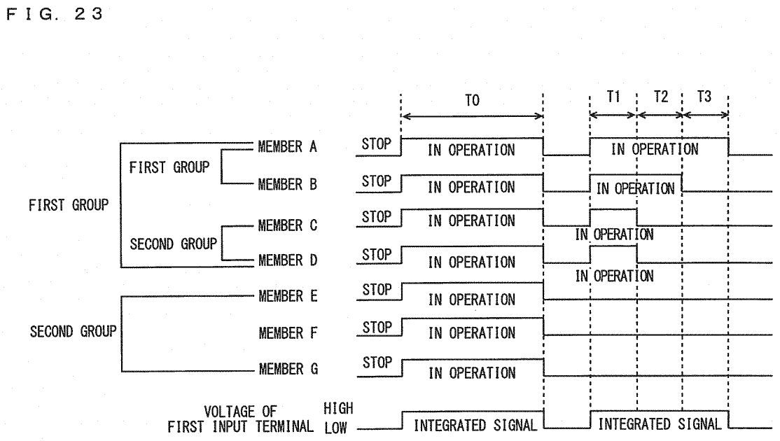

FIG. 23 is a second diagram showing one example of operation states of the members A to G and integrated signals. The abscissa indicates the time flow. A period T0 indicates the period in which an image processing operation is carried out. Here, the members A to G are respectively driven in the period T0. After the period T0, the members A to D that are classified into a first group are driven in parallel in a period T1. Because an integrated signal is detected in the period T1, at least one of the members A to D is abnormal.

In a period T2 following the period T1, the members A and B are classified into a first group, the members C and D are classified into a second group, and the members A and B that are classified in the first group are driven in parallel. Because an integrated signal is detected in the period T2, at least one of the members A and B is abnormal.

In a period T3 following the period T2, the member A is classified into a first group, the member B is classified into a second group, and the member A that is classified into the first group is driven. An integrated signal is detected in the period T3, so that the member A is abnormal.

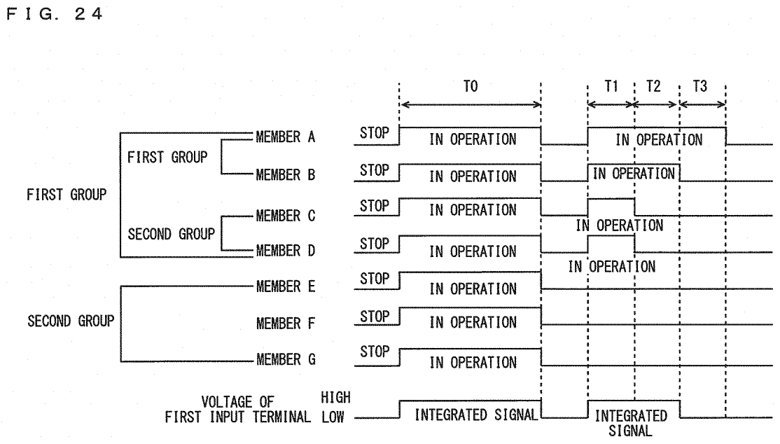

FIG. 24 is a third diagram showing one example of operation states of the members A to G and integrated signals. The abscissa indicates the time flow. A period T0 indicates the period in which an image processing operation is carried out. In the periods T0 to T2, the operation states and the integrated signals are the same as the ones shown in FIG. 23. In the period T3 following the period T2, the member A is classified into a first group, the member B is classified into a second group, and the member A that is classified into the first group is driven. Because an integrated signal is not detected in the period T3, the member B is abnormal.

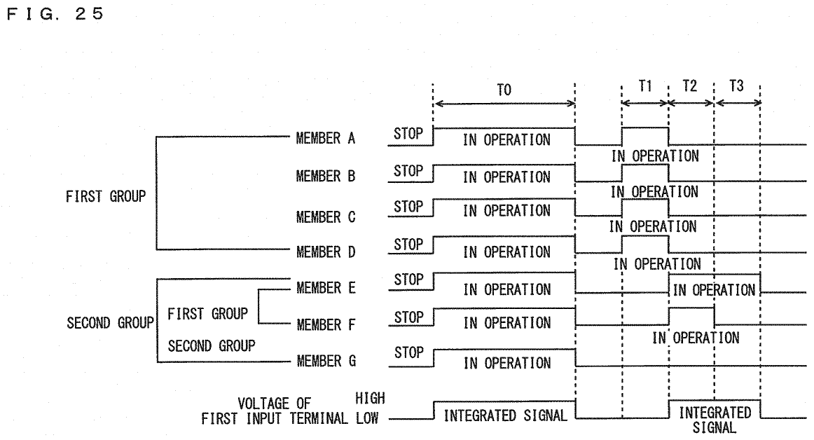

FIG. 25 is a fourth diagram showing one example of operation states of the members A to G and integrated signals. The abscissa indicates the time flow. A period T0 indicates the time period in which an image processing operation is carried out. Here, the members A to G are respectively driven in the period T0. After the period T0, the members A to D classified into a first group are driven in parallel in a period T1. Because an integrated signal is not detected in the period T1, at least one of the members E to G is abnormal.

In a period T2 following the period T1, the members E and F are classified into a first group, the member G is classified into a second group, and the members E and F that are classified into the first group are driven in parallel. Because an integrated signal is detected in the period T2, at least one of the members E and F is abnormal.

In a period T3 following the period T2, the member E is classified into a first group, the member F is classified into a second group, and the member E that is classified into the first group is driven. Because an integrated signal is detected in the period T3, the member E is abnormal.

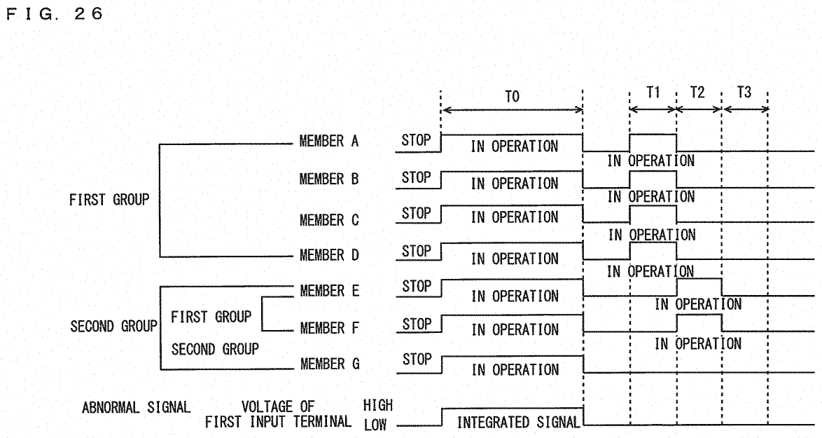

FIG. 26 is a fifth diagram showing one example of operation states of the members A to G and integrated signals. The abscissa indicates the time flow. A period T0 indicates the period in which the image processing operation is carried out. In the period T0 and T1, the operation states and the integrated signals are the same as the ones shown in the FIG. 25.

In a period T2 following the period T1, the members E and F are classified into a first group, the member G is classified into a second group, and the member E and F that are classified into the first group are driven in parallel. Because an integrated signal is not detected in the period T2, the member G is abnormal.

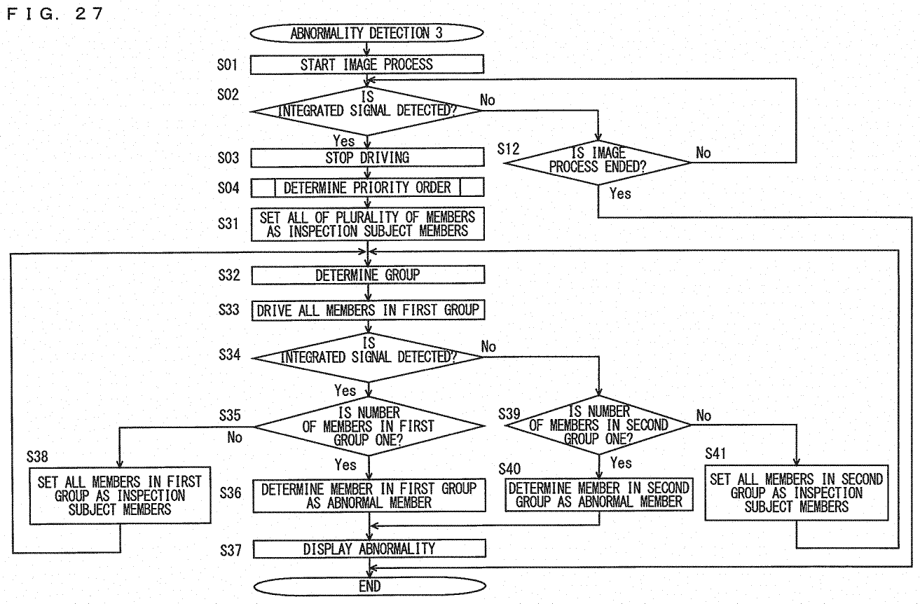

FIG. 27 is a flow chart showing one example of a flow of an abnormality detection process in the second embodiment. Referring to FIG. 27, the steps S01A to S04 and the step S12 are respectively the same as the steps S01A to S04 and the step S12 shown in FIG. 10. Thus, a description thereof will not be repeated.

If CPU 111 determines the priority order in the step S04, the process proceeds to the step S31. The CPU 111 sets all of the members A to G that are the normal members as inspection subject members in the step S31, and the process proceeds to the step S32. In the step S32, the CPU 111 determines groups. Specifically, the CPU 111 classifies the plurality of members that are set as the inspection subject members into a first group and a second group and drives all of the one or more members that belong to the first group (step S33). Then, the process proceeds to the step S34.

In the step S34, the CPU 111 determines whether an integrated signal is detected. If an integrated signal is detected, the process proceeds to the step S35. If not, the process proceeds to the step S39. In the step S35, the CPU 111 determines whether the number of members that belong to the first group is one. If the number of members that belong to the first group is one, the process proceeds to the step S36. If not, the process proceeds to the step S38. In the step S36, the CPU 111 determines the member that belongs to the first group as an abnormal member, and the process proceeds to the step S37. In the step S38, the CPU 111 sets all of the plurality of members that belong to the first group as inspection subject members, and the process returns to the step S32.

In the step S39, the CPU 111 determines whether the number of members that belong to the second group is one. If the number of members that belong to the second group is one, the process proceeds to the step S40. If not, the process proceeds to the step S41. In the step S40, the member that belongs to the second group is determined as an abnormal member, and the process proceeds to the step S37. In the step S41, all of the plurality of members that belong to the second group are set as inspection subject members, and the process returns to the step S32.

In the step S37, abnormality is displayed, and the process ends. In the case where the process proceeds from the step S36, the member identification information for identifying the member that belongs to the first group is displayed in the display unit 161. In the case where the process proceeds from the step S40, the member identification information for identifying the member that belongs to the second group is displayed in the display unit 161. Thus, a service person who is in charge of repairing the MFP 100 can be notified of the abnormal member. Therefore, the service person can immediately perform an operation such as replacing the abnormal member.

The MFP 100 in the second embodiment sets two or more than two of the plurality of normal members as inspection subject members, classifies the two or more inspection subject members into a first group or a second group, and drives one or more subject inspection members that belong to the first group in parallel with one or more inspection subject members that belong to the second group not being driven. Thus, the number of times the inspection subject members are driven can be reduced. Therefore, the time required for specifying an abnormal member can be shortened.

Further, the CPU 111 sets all of normal members, among a plurality of normal members, that are driven while an image processing operation is being carried out and an integral signal is being detected as inspection subject members, and does not set any of the normal members that are not driven while an integral signal is being inspected as an inspection subject member. Therefore, the number of inspection subject members can be reduced. Thus, the time required for specifying an abnormal member can be shortened.

While the MFP 100 in the second embodiment determines one or more normal members that belong to a first group in the order of descending priority, the order being defined with respect to each of a plurality of normal members. Thus, the normal members can be driven in the standalone mode in the order of descending probability of being abnormal. Therefore, the normal member that is abnormal can be specified as quickly as possible.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image processing apparatus comprising:
a member controller that controls a drive prevented member that is prevented in advance from being driven in a standalone mode while an image processing operation is not being carried out, and a plurality of other normal members that are not the drive prevented member; and
a hardware processor, wherein
the hardware processor allows at least one of the plurality of normal members to be driven after an integrated signal indicating abnormality in at least one of the plurality of normal members is detected, and determines an abnormal member having abnormality from among the plurality of normal members based on presence or absence of the integrated signal with at least one of the plurality of normal members being driven.

2. The image processing apparatus according to claim 1, wherein
the hardware processor detects abnormality in the drive prevented member.

3. The image processing apparatus according to claim 1, wherein
the member controller allows the plurality of normal members to be driven in a standalone mode.

4. The image processing apparatus according to claim 1, wherein
the member controller
sets two or more than two of the plurality of normal members as inspection subject members, and classifies the two or more inspection subject members into a first group and a second group, and
allows one or more inspection subject members belonging to the first group to be driven in parallel with one or more inspection subject members belonging to the second group not being driven.

5. The image processing apparatus according to claim 4, wherein
the member controller
sets all of the plurality of normal members as the inspection subject members after the integrated signal is detected while an image process is being carried out,
in the case where the integrated signal is detected while the plurality of inspection subject members belonging to the first group are being driven in parallel, sets the plurality of inspection subject members belonging the first group as new inspection subject members, and
in the case where the integrated signal is not detected while the plurality of inspection subject members belonging to the first group are being driven in parallel, sets the plurality of inspection subject members belonging to the second group as new inspection subject members, and
the hardware processor,
in the case where one inspection subject member belongs to the first group, when the integral signal is detected while the one inspection subject member belonging to the first group is being driven, determines the one inspection subject member belonging to the first group as the abnormal member, and
in the case where one inspection subject member belongs to the second group, when the integral signal is not detected while one or more inspection subject members belonging to the first group are being driven, determines the one inspection subject member belonging to the second group as the abnormal member.

6. The image processing apparatus according to claim 5, wherein
the member controller,
in the case where a normal member that is being driven and a normal member that is not being driven are present among the plurality of normal members while an image processing operation is being carried out and the integrated signal is being detected, sets all of the normal members being driven as the inspection subject members, and does not set any of the normal members that are not being driven as the inspection subject members.

7. The image processing apparatus according to claim 4, wherein
the member controller
acquires an operation condition, and
determines the two or more normal members that are to be set as the inspection subject members based on the operation condition.

8. The image processing apparatus according to claim 4, wherein
the member controller determines the one or more normal members belonging to the first group in an order of descending priority, the order being defined with respect to the plurality of normal members.

9. An abnormal member detection method that is performed in an image processing apparatus, including:
a member control step of controlling a drive prevented member that is prevented in advance from being driven in a standalone mode while an image processing operation is not being carried out, and a plurality of other normal members that are not the drive prevented member;
a step of allowing at least one of the plurality of normal members to be driven after an integrated signal indicating abnormality in at least one of the plurality of normal members is detected; and
an abnormal member determining step of determining an abnormal member having abnormality from among the plurality of normal members based on presence or absence of the integrated signal with at least one of the plurality of normal members being driven.

10. The abnormal member detection method according to claim 9, further including an individual detection step of detecting abnormality in the drive prevented member.

11. The image processing apparatus according to claim 9, wherein
the member control step includes allowing the plurality of normal members to be driven in a standalone mode.

12. The abnormal member detection method according to claim 9, wherein
the member control step includes
a group production step of setting two or more than two of the plurality of normal members as inspection subject members, and classifying the two or more inspection subject members into a first group and a second group, and
a group unit control step of allowing one or more inspection subject members belonging to the first group to be driven in parallel with one or more inspection subject members belonging to the second group not being driven.

13. The abnormal member detection method according to claim 12 wherein
the group production step includes
an initial setting step of setting all of the plurality of normal members as the inspection subject members after the integrated signal is detected while an image process is being carried out,
a first setting step of, in the case where the integrated signal is detected while the plurality of inspection subject members belonging to the first group are being driven in parallel, setting the plurality of inspection subject members belonging to the first group as new inspection subject members, and
a second setting step of, in the case where the integrated signal is not detected while the plurality of inspection subject members belonging to the first group are being driven in parallel, setting the plurality of inspection subject members belonging to the second group as new inspection subject members, and
the abnormal member determining step includes
a first determining step of, in the case where one inspection subject member belongs to the first group, when the integral signal is detected while the one inspection subject member belonging to the first group is being driven, determining the one inspection subject member belonging to the first group as the abnormal member, and
a second determination step of, in the case where one inspection subject member belongs to the second group, when the integral signal is not detected while the one or more inspection subject members belonging to the first group are being driven, determining the one inspection subject member belonging to the second group as the abnormal member.

14. The abnormal member detection method according to claim 13, wherein
the initial setting step includes, in the case where a normal member that is being driven and a normal member that is not being driven are present among the plurality of normal members while an image processing operation is being carried out and the integrated signal is being detected, setting all of the normal members being driven as the inspection subject members, and not setting any of the normal members that are not being driven as the inspection subject members.

15. The abnormal member detection method according to claim 12,
further including an operation condition acquiring step of acquiring an operation condition, wherein
the group production step includes determining the two or more normal members that are to be set as the inspection subject members based on the operation condition.

16. The image processing apparatus according to claim 12, wherein
the group production step includes determining the one or more normal members belonging to the first group in an order of descending priority, the order being defined with respect to the plurality of normal members.

17. A non-transitory computer-readable recording medium encoded with an abnormal member detection program that is executed in a computer controlling an image processing apparatus,
the abnormal member detection program allowing the computer to:
control a drive prevented member that is prevented in advance from being driven in a standalone mode while an image processing operation is not being carried out, and a plurality of other normal members that are not the drive prevented member; and
allow at least one of the plurality of normal members to be driven after an integrated signal indicating abnormality in at least one of the plurality of normal members is detected, and
determine an abnormal member having abnormality from among the plurality of normal members based on presence or absence of the integrated signal with at least one of the plurality of normal members being driven.
